(19) United States
(12) Patent Application Publication
(10) Pub. No.: US 2005/0139708 A1
(43) Pub. Date: Jun. 30, 2005

(54) Tape reel assembly with wear resistant driven teeth

(76) Inventors: Jason D. Hanzlik, Wahpeton, ND (US); Jason E. Moses, St. Paul, MN (US); G. Phillip Rambosek, Shafer, MN (US)

Correspondence Address: Imation Corp., PO Box 64898, St. Paul, MN, 55164-0898, US

(21) Appl. No.: 10/730,698

(22) Filed: Dec. 8, 2003

(51) Int. Cl. G03B 23/02

(52) U.S. Cl. 242/342

(57) ABSTRACT

One aspect of the present invention relates to a tape reel assembly. The tape reel assembly includes a hub defining a tape-winding surface and driven teeth defining an engagement surface. In this regard, the driven teeth are formed from a polymer including a lubricating additive.

### THE FIELD OF THE INVENTION

The present invention relates to a tape reel assembly for a data storage tape cartridge. More particularly, it relates to a tape reel assembly having wear resistant driven teeth.

### BACKGROUND OF THE INVENTION

Data storage tape cartridges have been used for decades in the computer, audio, and video fields. The data storage tape cartridge continues to be a popular device for recording large volumes of information for subsequent retrieval and use.

A data storage tape cartridge generally consists of an outer shell or housing maintaining at least one tape reel assembly and a length of magnetic storage tape. The storage tape is wrapped about a hub portion of the tape reel assembly and is driven through a defined path by a tape drive system. The housing normally includes a separate cover and a separate base. Together, the cover and base form an opening (or window) at a forward portion thereof permitting access to the storage tape by a read/write head upon insertion of the data storage tape cartridge into a tape drive. The interaction between the storage tape and head occurs within the housing for a mid-tape load design. Conversely, the interaction between the storage tape and head occurs exterior the housing where the read/write head is annexed for a helical drive design. Where the tape cartridge/drive system is designed to direct the storage tape away from the housing, the data storage tape cartridge normally includes a single tape reel assembly employing a leader block design. Alternately, where the tape cartridge/drive system is designed to provide head/storage tape interaction within the housing, a dual tape reel configuration is typically employed.

Regardless of the number of the tape reel assemblies associated with a particular data storage tape cartridge, the tape reel assembly itself is generally comprised of three elements: an upper flange, a lower flange, and a hub. The hub forms a tape-winding surface about which the storage tape is wound. The flanges are disposed at opposite ends of the hub and spaced apart to accommodate a width of the storage tape. To reduce the likelihood of the storage tape undesirably contacting one of the flanges during a winding operation, the flange-to-flange spacing is selected to be slightly greater than the width of the tape.

Reading information from, or writing information to, the storage tape requires the tape reel assembly to be rotated such that a desired portion of the storage tape can be located and accessed by a read/write head. To this end, the cartridge is inserted into the tape drive with the read/write head. The tape drive rotates the tape reel assembly, thereby driving the tape across the read/write head. To facilitate this operation, tape reel assemblies have driven teeth suited for engagement by a drive chuck of the tape drive. The drive chuck engages the driven teeth of the tape reel assembly (known as “chuck-up”) and rotates (i.e., drives) the tape reel assembly to wind/unwind the data storage tape. Significantly, the drive chuck is typically formed of a hardened material, often metal. Consequently, the drive chuck can cause the driven teeth to wear.

Tape reel assemblies are typically formed from plastic components. Plastic driven teeth, though cost effective, can be ablated by the drive chuck. As the driven teeth wear down, debris is created. The debris from the driven teeth can be spread throughout the tape drive system. In particular, debris spread to the data storage tape can interfere with the reading and writing of information to the data storage tape. In addition, frequent access to the information stored on the data storage tape necessitates frequent tape reel assembly/drive chuck interaction, leading to increased debris generation. Eventually, debris from worn driven teeth can contribute to cartridge loading failures, read/write errors, and other system problems.

Data storage tape cartridges are useful tools for collecting and protecting information stored on data storage tape. However, the driven teeth of the tape reel assembly are vulnerable to wear when repeatedly engaged by the drive chuck of the tape drive system. In particular, plastic driven teeth create debris as they wear. To this end, debris generation during tape reel/tape drive engagement can create errors in reading from, and writing to, the storage tape. Therefore, a need exists for a tape reel assembly having wear resistant driven teeth.

### SUMMARY OF THE INVENTION

One aspect of the present invention relates to a tape reel assembly for a data storage tape cartridge. The tape reel assembly includes a hub defining a tape-winding surface and driven teeth defining an engagement surface. In this regard, the driven teeth are formed from a polymer including a lubricating additive.

Another aspect of the present invention relates to a data storage tape cartridge. The data storage tape cartridge includes a housing defining an enclosed region, at least one tape reel assembly, and a storage tape. The tape reel assembly is rotatably disposed within the enclosed region and includes a hub defining a tape-winding surface and driven teeth defining an engagement surface. In this regard, the driven teeth are formed from a polymer including a lubricating additive.

Yet another aspect of the present invention relates to a method of fabricating a tape reel assembly for a data storage tape cartridge. The method includes providing a polymer including a lubricating additive. The method additionally includes forming driven teeth defining an engagement surface from the polymer. The method ultimately includes generating a hub to which the driven teeth are connected.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a perspective, exploded view of a single reel, data storage tape cartridge in accordance with the invention showing a tape reel assembly;

FIG. 2 is an exploded view of a tape reel assembly including a flange with driven teeth according to one embodiment of the present invention;

FIG. 3 is a cross-sectional view of the flange shown in FIG. 2;

FIG. 4 is a cross-sectional view of a tape drive system including the cartridge of FIG. 1 according to one embodiment of the present invention;

FIG. 5 is an exploded view of a tape reel assembly including a hub having driven teeth according to another embodiment of the present invention; and

FIG. 6 is a cross-sectional view of the hub shown in FIG. 5.

### DETAILED DESCRIPTION OF THE PREFERRED EMBODIMENTS

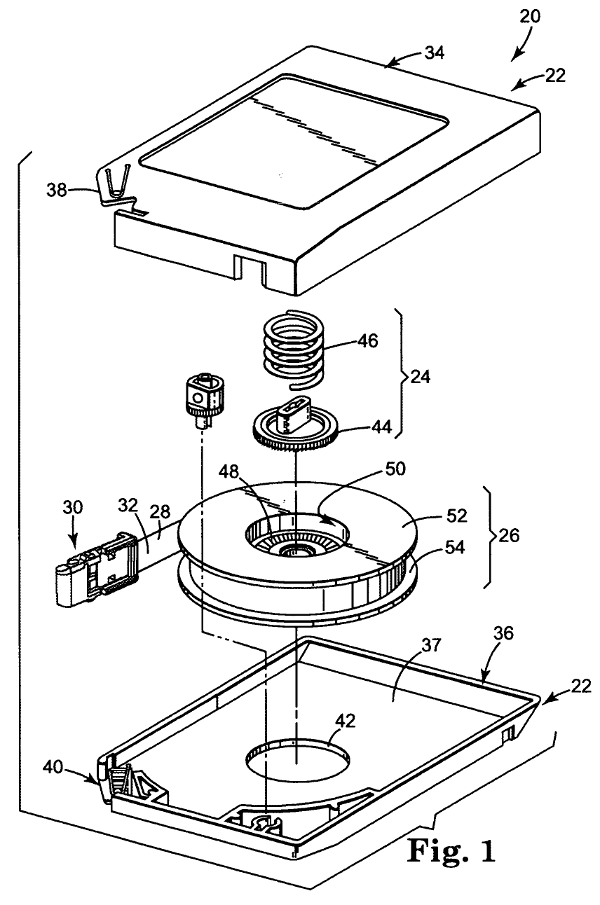

An exemplary single reel data storage tape cartridge according to one embodiment of the present invention is illustrated at 20 in FIG. 1. Generally, the data storage tape cartridge 20 includes a housing 22, a brake assembly 24, a tape reel assembly 26, a storage tape 28, and a leader block 30. The tape reel assembly 26 is disposed within the housing 22. The storage tape 28, in turn, is wound about the tape reel assembly 26 and includes a leading end 32 attached to the leader block 30. As a point of reference, while a single reel data storage tape cartridge 20 is shown, the present invention is equally applicable to other cartridge configurations, such as dual reel cartridges.

The housing 22 is sized for insertion into a typical tape drive (not shown). Thus, the housing 22 exhibits a size of approximately 125 mm×110 mm×21 mm, although other dimensions are equally acceptable. With this in mind, the housing 22 is defined by a first housing section 34 and a second housing section 36. In one embodiment, the first housing section 34 forms a cover and the second housing section 36 forms a base. As used throughout the specification, directional terminology such as “cover,” “base,” “upper,” “lower,” “top,” “bottom,” etc., is employed for purposes of illustration only and is in no way limiting.

The first and second housing sections 34 and 36, respectively, are sized to be reciprocally mated to one another to form an enclosed region 37 and are generally rectangular, except for one corner 38 that is preferably angled and forms a tape access window 40. The tape access window 40 serves as an opening for the storage tape 28 to exit from the housing 22 such that the storage tape 28 can be threaded to a tape drive system (not shown) when the leader block 30 is removed from the tape access window 40. Conversely, when the leader block 30 is stowed in the tape access window 40, the tape access window 40 is covered.

In addition to forming a portion of the tape access window 40, the second housing section 36 also forms a central opening 42. The central opening 42 facilitates access to the tape reel assembly 26 by a drive chuck of the tape drive (not shown). During use, the drive chuck enters the central opening 42 to disengage the brake assembly 24 prior to rotating the tape reel assembly 26 for access to the storage tape 28. The brake assembly 24 is of a type known in the art and generally includes a brake body 44 and a spring 46 co-axially disposed within the tape reel assembly 26. When the data storage tape cartridge 20 is idle, the brake assembly 24 is engaged with a brake interface 48 to selectively “lock” the single tape reel assembly 26 to the housing 22.

The storage tape 28 is preferably a magnetic tape of a type commonly known in the art. For example, the storage tape 28 may consist of a balanced polyethylene naphthalate (PEN) based material coated on one side with a layer of magnetic material dispersed within a suitable binder system and coated on the other side with a conductive material dispersed within a suitable binder system. Acceptable magnetic tape is available, for example, from Imation Corp., of Oakdale, MN.

The leader block 30 covers the tape access window 40 during storage of the cartridge 20 and facilitates retrieval of the storage tape 28 for read/write operations. In general terms, the leader block 30 is shaped to conform to the window 40 of the housing 22 and to cooperate with the tape drive (not shown) by providing a grasping surface for the tape drive to manipulate in delivering the storage tape 28 to the read/write head. In this regard, the leader block 30 can be replaced by other components, such as a dumb-bell shaped pin. Moreover, the leader block 30, or a similar component, can be eliminated entirely, as is the case with dual reel cartridge designs.

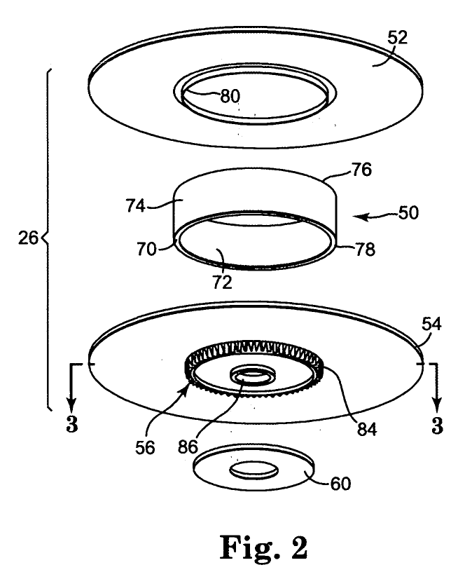

The present invention, as more fully described below, is beneficially employed in cartridges with either a single tape reel assembly or a multiple tape reel assembly design. With this in mind, and with reference to FIGS. 1 and 2, the tape reel assembly 26 comprises a hub 50, an upper flange 52, a lower flange 54, and driven teeth 56. The upper and lower flanges 52, 54 extend in a radial fashion from opposing sides of the hub 50, respectively. The driven teeth 56 can be disposed on (or formed by) the hub 50 or the lower flange 54, as described below.

FIG. 2 is an exploded view of the tape reel assembly 26 shown in FIG. 1. The tape reel assembly 26 includes the hub 50 positioned between the upper flange 52 and the lower flange 54. As illustrated, the lower flange 54 includes the driven teeth 56. In one embodiment, the tape reel assembly 26 further includes a metallic washer 60. The lower flange 54 can be molded about the washer 60, or the washer 60 can be separately assembled to the lower flange 54. Regardless, the washer 60 is adapted to magnetically couple the tape reel assembly 26 to a magnet within the tape drive (not shown).

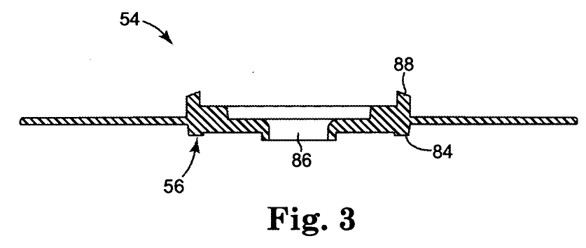

The hub 50 includes a core 70 and defines an interior surface 72 and a tape-winding surface 74. The tape-winding surface 74 is configured for acceptance of the data storage tape 28 (FIG. 1). In this regard, the tape-winding surface 74 is located between a first end 76 and a second end 78 of the hub 50. The upper flange 52 couples to the first end 76 of the hub 50 via an interior edge 80. The lower flange 54 couples to the second end 78 of the hub 50 via a crown, as best illustrated in FIG. 3 below.

With additional reference to FIG. 3, the lower flange 54 includes the driven teeth 56 that define an engagement surface 84. In addition, the lower flange 54 defines an axial bore 86 about which the washer 60 is disposed. In this regard, the axial bore 86 is centrally located within the lower flange 54. Further, the lower flange 54 includes a crown 88 configured to couple with the second end 78 of the hub 50 such that upon final assembly, the lower flange 54 extends in a radial fashion from the hub 50. In the embodiment of FIG. 3, the lower flange 54 and the driven teeth 56 are integrally formed. To this end, the material employed to form the lower flange 54 and the driven teeth 56 is a polymer including a lubricating additive. In particular, the polymer imparts stiffness to the flange 54 and the lubricating additive lubricates the driven teeth 56 such that they resist wear when engaged by the drive chuck of the tape drive (not shown).

The lubricating additive can be any melt processable additive that reduces the abrasion between the driven teeth 56 and the drive chuck (not shown). Suitable lubricating additives include, but are not limited to, silicones, waxes, polytetrafluoroethylene, fluoroploymers, fluorochemicals, and oils. The lubricating additive can be compounded into the polymer, or alternately, the lubricating additive can simply be blended into the polymer. In any regard, the lubricating additive is melt processable and serves to increase the lubricity of the driven teeth 56 and the engagement surface 84.

The lubricating additive is preferably added to the polymer in the range of 0.5 to 25% by weight, more preferably, the lubricating additive is added to the polymer in the range of 2-10% by weight, and most preferably the lubricating additive is added to the polymer at 5% by weight.

In a preferred embodiment, the driven teeth 56 are formed from a polymer including a glass-filled polycarbonate and polytetrafluoroethylene as a lubricating additive added at up to 25% by weight. For example, it has been advantageously discovered and described herein that driven teeth 56 formed from a polymer including 20% glass-filled polycarbonate and 5% polytetrafluoroethylene will resist wear associated with more than 10,000 engagements with the drive chuck (not shown).

After formation of the tape reel assembly 26, the lubricating additive resides in the driven teeth 56 and is present on the engagement surface 84 of the lower flange 54. In one embodiment, the driven teeth 56 are formed from a polymer including glass-filled polycarbonate for stiffness and a lubricating additive for abrasion resistance (i.e., lubricity). In particular, the lubricating additive in the driven teeth 56 and present on the engagement surface 84 permits thousands of couplings of the tape reel assembly 26 to the drive chuck (not shown) without appreciable wear being imparted to the driven teeth 56. The lubricated driven teeth 56 according to the present invention generate much less debris than conventional driven teeth, and contribute to error free loading of the data storage tape cartridge 20 (FIG. 1) into the tape drive.

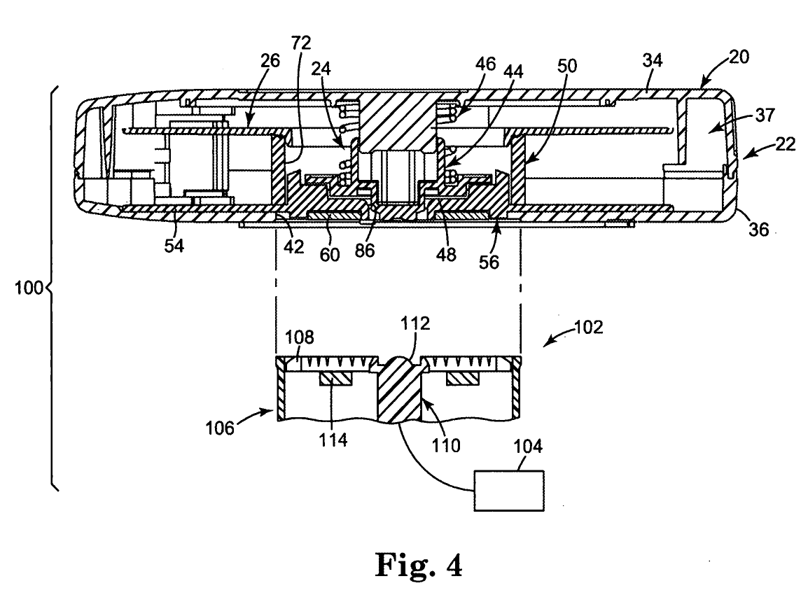

The data storage tape cartridge 20 including the tape reel assembly 26 is shown in a final, assembled form in FIG. 4. For ease of illustration, the storage tape 28 (FIG. 1) has been omitted from the view of FIG. 4. As previously described, the brake assembly 24 and the tape reel assembly 26 are disposed within the enclosed region 37 defined by the housing 22. In this regard, the central bore 86 defined by the lower flange 54 is axially aligned with the opening 42 in the second housing section 36. Further, the brake body 44 is disposed adjacent the inner surface 72 of the hub 50. The spring 46 is similarly disposed co-axially with the brake body 44. With this configuration, the spring 46 urges the brake body 44 into a locked position relative to the tape reel assembly 26. In this locked position, the brake body 44 engages the brake interface 48 of the tape reel assembly 26. The brake body 44 effectively rigidly connects the tape reel assembly 26 to the housing 22, thereby preventing unexpected rotation of the tape reel assembly 26 relative to the housing 22 when in the locked position.

As a point of reference, the data storage tape cartridge 20 is shown in FIG. 4 as part of a tape drive system 100. The tape drive system 100 includes the data storage tape cartridge 20 and a tape drive 102. The tape drive 102 includes a motor 104 (shown schematically) and a drive chuck 106. The drive chuck 106 is rotatably driven by the motor 104 and includes engagement teeth 108 and a spindle 110. In particular, the engagement teeth 108 are connected to the spindle 110, with the spindle 110 terminated at a rounded tip 112. In a preferred embodiment, the drive chuck 106 includes a magnet 114 that attracts the washer 60 of the tape reel assembly 26 during chuck-up of the data storage tape cartridge 20 with the tape drive 102.

Reading or writing information to the storage tape 28 (FIG. 1) is accomplished by the tape drive system 100. The data storage tape cartridge 20 is inserted into the tape drive 102. The tape drive system 100 causes the spindle 110 to disengage the brake assembly 24 such that the drive chuck 106 engages with the tape reel assembly 26 immediately thereafter. More particularly, as shown in FIG. 4, the rounded tip 112 of the spindle 110 guides the brake body 44 out of the locked position. The movement of the spindle 110 (upward relative to the orientation of FIG. 4) overcomes the bias of the spring 46, causing the brake body 44 to disengage from the brake interface 48 of the tape reel assembly 26. The drive chuck 106 continues upward into the central opening 42 until the magnet 114 couples with the washer 60, after which the engagement teeth 108 of the drive chuck 106 engage the driven teeth 56 of the tape reel assembly 26. Ultimately, the magnet 114 attracts the washer 60 to ensure proper alignment of the tape reel assembly 26 with the tape drive 102.

After the cartridge 20 is engaged in the tape drive 102, the drive chuck 106, when rotated by the motor 104, rotates the tape reel assembly 26. During some read/write operations, the tape reel assembly 26 can be rotated at speeds on the order of 2000 RPM or more to achieve data storage tape 28 (FIG. 1) speeds on the order of 10 meters per second.

Cartridge loading failures are characterized by a rejection of the data storage tape cartridge by the tape drive, thus interfering with the reading and writing of data to the data storage tape. In accordance with the present invention, an improved tape reel assembly is disclosed having wear resistant driven teeth that enable more than 10,000 insertions of the cartridge 20 into the tape drive 102 without a loading failure. In particular, during use, the tape reel assembly 26 maintains a length of the storage tape 28 (FIG. 1) wrapped about the hub 50 and contained between the flanges 52, 54. The wrapping of successive layers of the storage tape 28 creates a compressive force on the hub 50 that can deform the hub 50 and the flanges 52, 54. In addition, over the course of thousands of tape reel assembly 26/drive chuck 106 engagements (i.e., chuck-ups), the driven teeth 56 will wear and create debris. To this end, and in one embodiment, at least the driven teeth 56 are formed of a stiff polymer including a lubricating additive.

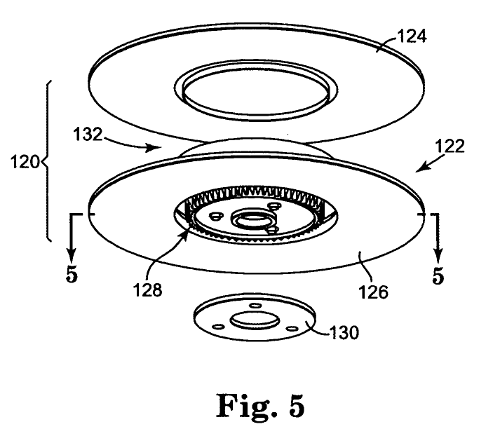

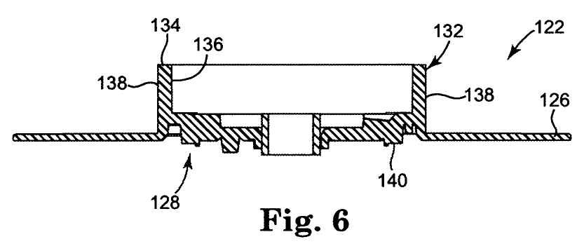

An alternative embodiment of a tape reel assembly 120 in accordance with the present invention is illustrated in FIGS. 5 and 6. FIG. 5 is a perspective view illustrating the tape reel assembly 120 as a two-piece assembly including a hub portion 122 and an upper flange 124. With the embodiment of FIG. 5, the driven teeth 128 are formed as extensions of the hub 132. The hub portion 122 includes an integrally formed lower flange 126, the driven teeth 128, and a hub 132. In addition, the tape reel assembly 120 can include a metallic washer 130. The lower flange 126 can be molded about the washer 130, or the washer 130 can be separately assembled to the lower flange 126.

A cross-sectional view of the hub portion 122 in accordance with the present invention is illustrated in FIG. 6. As shown, the hub portion 122 includes the hub 132 and the integrally formed lower flange 126. The hub 132 includes a core 134 that defines an inner surface 136 and a tape-winding surface 138, and the driven teeth 128. The driven teeth 128 define an engagement surface 140.

As described above, the wrapping of successive layers of the storage tape 28 (FIG. 1) can create a compressive force on the hub portion 122 that can deform the hub 132 and the flanges 124, 126. It is desired that the tape reel assembly 120 resist this deformation, and resist the wear associated with drive chuck 106 (FIG. 4) engagements (i.e., chuck-ups). To this end, at least the driven teeth 128 are formed of a stiff polymer including a lubricating additive as previously described. With the embodiments of FIGS. 5 and 6, the hub portion 122 integrally forms the driven teeth 128, with the hub portion 122 being molded from a polymer material including a lubricating additive. In a preferred embodiment, the hub portion 122, and thus the driven teeth 128, is formed from a polymer that includes a glass-filled polycarbonate and polytetrafluoroethylene as a lubricating additive added at up to 25% by weight. The lubricating additive can be any of the melt processable additives described above. Specifically, it has been advantageously discovered and described herein that driven teeth 128 formed from a polymer including 20% glass-filled polycarbonate and 5% polytetrafluoroethylene will resist wear associated with more than 10,000 engagements with the drive chuck 106 (FIG. 4).

### EXAMPLES AND COMPARATIVE EXAMPLE

The following examples further describe the tape reel assemblies of the present invention, methods of forming the tape reel assemblies, and the tests performed to determine their various characteristics. The examples are provided for exemplary purposes to facilitate an understanding of the invention, and should not be construed to limit the invention to the examples.

Tape reel assemblies were constructed as described below, and assembled into a set of data storage tape cartridges. Each of the cartridges were then repeatedly loaded into a series of side-loading tape drives from Seagate Removable Storage Solutions, now Certance of Costa Mesa, Calif. During loading, a drive chuck of the tape drive engaged, rotated, and disengaged a respective one of the tape reel assemblies. The series of steps including loading of the cartridge into the tape drive, the drive chuck engaging, rotating, and disengaging with the tape reel assembly, and unloading of the cartridge is designated as a “cycle.” A successful cycle is defined to be the completion of each of the steps listed above. An unsuccessful cycle is a cycle having a cartridge loading failure, or a cycle wherein a cartridge is rejected by the tape drive. When a cartridge tallies 10,000 successful cycles, the cartridge is said to “pass” the challenge. A “pass rate” represents the number of cartridges that pass the challenge in relation to the number of cartridges that were subjected to the challenge. For each Example and Comparative Example, the number of successful cycles was recorded, with the pass rate appearing in Table 1.

### Example 1

Tape reel assemblies according to FIG. 2 were constructed having driven teeth formed from a polymer including 20% glass-filled polycarbonate and 5% polytetrafluoroethylene (PTFE) added as a lubricating additive. Specifically, the polymer was compounded to include the 20% glass-filled polycarbonate and the 5% PTFE, where the PTFE was in the form of Teflon®. The polymer is identified as LNP DFL 4014 BK8-115, available from LNP, A GE Plastics Company, of Exton, PA. The tape reel assemblies of Example 1 were assembled into a set of 8 data storage tape cartridges. As shown in Table 1, the tape reel assemblies of Example 1 had a cartridge loading pass rate of 8 out of 8 and no cartridge loading failures. In this example, each of the cartridges containing the tape reel assemblies of Example 1 were successfully loaded into the tape drives for 10,000 cycles with zero loading failures before the experiment was terminated.

### Example 2

Tape reel assemblies according to FIG. 2 were constructed having driven teeth formed from a polymer including 10% glass-filled polycarbonate and 5% polytetrafluoroethylene (PTFE) added as a lubricating additive. Specifically, the polymer was compounded to include the 10% glass-filled polycarbonate and the 5% PTFE, where the PTFE was in the form of Teflon®. The polymer is identified as RTP 301 TFE 5, available from RTP Company, Winona, Minn. The tape reel assemblies of Example 2 were assembled into a set of 8 data storage tape cartridges. As shown in Table 1, the tape reel assemblies of Example 2 had a cartridge loading pass rate of 8 out of 8 with no cartridge loading failures. In this example, each of the cartridges were successfully loaded into the tape drives more than 11,800 cycles with zero cartridge loading failures before the experiment was terminated.

### Example 3

Tape reel assemblies according to FIG. 2 were constructed having driven teeth formed from a polymer including 10% glass-filled polycarbonate and 10% polytetrafluoroethylene (PTFE) added as a lubricating additive. Specifically, the polymer was compounded to include the 10% glass-filled polycarbonate and the 10% PTFE, where the PTFE was in the form of Teflon®. The polymer is identified as RTP 301 TFE 10, available from RTP Company, Winona, Minn. The tape reel assemblies of Example 3 were assembled into a set of 8 data storage tape cartridges. As shown in Table 1, the tape reel assemblies of Example 3 had a cartridge loading pass rate of 8 out of 8 with no cartridge loading failures. In this example, each of the cartridges were successfully loaded into the tape drives more than 11,000 cycles with zero cartridge loading failures before the experiment was terminated.

### Example 4

Tape reel assemblies according to FIG. 2 were constructed having driven teeth formed from a polymer including a 10% glass-filled polycarbonate and 15% polytetrafluoroethylene (PTFE) added as a lubricating additive. Specifically, the polymer was compounded to include the 10% glass-filled polycarbonate and the 15% PTFE, where the PTFE was in the form of Teflon®. The polymer is identified as RTP 301 TFE 15, available from RTP Company, Winona, Minn. The tape reel assemblies of Example 4 were assembled into a set of 7 data storage tape cartridges. As shown in Table 1, the tape reel assemblies of Example 4 had a cartridge loading pass rate of 7 out of 7 with no cartridge loading failures. In this example, each of the cartridges were successfully loaded into the tape drives more than 11,000 cycles with zero cartridge loading failures before the experiment was terminated.

### Comparative Example 1

Tape reel assemblies according to FIG. 2 were constructed having driven teeth composed of 20% glass-filled polycarbonate material. The material is identified as ML 5369-739, available from GE Plastics, Pittsfield, Mass. The tape reel assemblies of Comparative Example 1 were assembled into a set of 8 data storage tape cartridges and subjected to the testing described above. The sample cartridges utilizing the tape reel assemblies of Comparative Example 1 had a cartridge loading pass rate of 5 out of 8. Notably, cartridges containing the Comparative Example 1 tape reel assemblies exhibited approximately 7,200 loading cycles on average prior to cartridge loading failure.

As represented in Table 1 below, the inventive tape reel assemblies (described above), having driven teeth formed from a polymer including PTFE as a lubricating additive, each exceeded the 10,000 cycle cartridge loading challenge with zero cartridge loading failures.

TABLE 1

| Driven teeth | 10,000 Cycle | | Average |
|---|---|---|---|
| Composition of Tape | Cartridge | Cartridge | Number of |
| Reel Assembly, | Loading Pass | Loading | Insertions before |
| Example | Rate | Failures | Loading Failure |
| 20% glass-filled | 8 of 8 | None | N/A |
| polycarbonate, 5% | | | |
| polytetrafluoroethylene | | | |
| (PTFE), Example 1 | | | |
| 10% glass-filled | 8 of 8 | None | N/A |
| polycarbonate, 5% | | | |
| PTFE, Example 2 | | | |
| 10% glass-filled | 8 of 8 | None | N/A |
| polycarbonate, 10% | | | |
| PTFE, Example 3 | | | |
| 10% glass-filled | 7 of 7 | None | N/A |
| polycarbonate, 15% | | | |
| PTFE, Example 4 | | | |
| Conventional glass- | 5 of 8 | 3 of 8 | 7117 |
| filled polycarbonate, | | | |
| Comparative Example 1 | | | |

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electromechanical, electrical, and computer arts will appreciate that the present invention can be implemented in a wide variety of embodiments. Specifically, a number of other tape reel assembly constructions other than those shown are within the scope of this invention. In particular, this application is intended to cover any adaptations or variations of tape reel assemblies having driven teeth formed from a polymer including a lubricating additive. Therefore, it is manifestly intended that this invention be limited only by the claims and the equivalents thereof.

1. A tape reel assembly for a data storage tape cartridge comprising:
a hub defining a tape winding surface; and
driven teeth defining an engagement surface;
wherein the driven teeth are formed from a polymer including a lubricating additive.

2. The tape reel assembly of claim 1, wherein the polymer includes up to 25% by weight lubricating additive.

3. The tape reel assembly of claim 1, wherein the tape reel assembly further includes:
a flange including the driven teeth, the flange coupled to and extending in a radial fashion from an end of the hub.

4. The tape reel assembly of claim 1, wherein the hub includes the driven teeth.

5. The tape reel assembly of claim 1, wherein the lubricating additive is selected from the group consisting of silicone, wax, polytetrafluoroethylene, fluoropolymer, fluorochemical, and oil.

6. The tape reel assembly of claim 1, wherein the driven teeth are formed from a polymer including a glass-filled polycarbonate and the lubricating additive.

7. The tape reel assembly of claim 6, wherein the polycarbonate is 20% glass-filled and the lubricating additive is polytetrafluoroethylene added to the polymer at approximately 5% by weight.

8. The tape reel assembly of claim 1, wherein the lubricating additive is added to the polymer in the range of 2-10% by weight.

9. The tape reel assembly of claim 1, wherein the lubricating additive is added to the polymer at approximately 5% by weight.

10. A data storage tape cartridge comprising:
a housing defining an enclosed region;
at least one tape reel assembly rotatably disposed within the enclosed region and including:
a hub defining a tape-winding surface,
driven teeth defining an engagement surface; and
a storage tape wound about the tape-winding surface;
wherein the driven teeth are formed from a polymer including a lubricating additive.

11. The data storage tape cartridge of claim 10, wherein the polymer includes up to 25% by weight lubricating additive.

12. The data storage tape cartridge of claim 10, wherein the tape reel assembly further includes:
a flange including the driven teeth, the flange coupled to and extending in a radial fashion from an end of the hub.

13. The data storage tape cartridge of claim 10, wherein the hub includes the driven teeth.

14. The data storage tape cartridge of claim 10, wherein the lubricating additive is selected from the group consisting of silicone, wax, polytetrafluoroethylene, fluoropolymer, fluorochemical, and oil.

15. The data storage tape cartridge of claim 10, wherein the driven teeth are formed from a polymer including a glass-filled polycarbonate and the lubricating additive.

16. The data storage tape cartridge of claim 15, wherein the polycarbonate is 20% glass-filled and the lubricating additive is polytetrafluoroethylene added to the polymer at approximately 5% by weight.

17. A method of fabricating a tape reel assembly for a data storage tape cartridge comprising:
providing a polymer including a lubricating additive;
forming driven teeth defining an engagement surface from the polymer; and
generating a hub to which the driven teeth are connected.

18. The method of claim 17, wherein providing a polymer includes providing a polymer including up to 25% by weight lubricating additive.

19. The method of claim 17, wherein generating a hub includes generating a hub with the driven teeth integrally formed thereon.

20. The method of claim 17, wherein generating a hub includes generating a hub including an integrally formed lower flange, the hub having the driven teeth integrally formed thereon.

21. The method of claim 17, wherein generating a hub includes generating a hub including an integrally formed lower flange, the lower flange having the driven teeth integrally formed thereon.

22. The method of claim 17, wherein forming driven teeth includes forming at least one flange including the driven teeth, the at least one flange coupled to and extending in a radial fashion from an end of the hub.

23. The method of claim 17, wherein the lubricating additive is selected from the group consisting of silicone, wax, polytetrafluoroethylene, fluoropolymer, fluorochemical, and oil.

24. The method of claim 17, wherein providing a polymer includes providing a polymer having 20% glass-filled polycarbonate and approximately 5% polytetrafluoroethylene by weight.

25. The method of claim 17, wherein providing a polymer includes providing a polymer compound.

26. The method of claim 17, wherein providing a polymer includes providing a polymer blend.
